(19) United States
(12) Patent Application Publication
(10) Pub. No.: US 2012/0214060 A1
(43) Pub. Date: Aug. 23, 2012

(54) LEAD MEMBER

(76) Inventors: Akihiko TAGUCHI, Kanuma-shi (JP); Hiroyasu Sugiyama, Kanuma-shi (JP); Yasuhiro Ishido, Kanuma-shi (JP)

(21) Appl. No.: 13/399,812

(22) Filed: Feb. 17, 2012

(30) Foreign Application Priority Data
Feb. 17, 2011 (JP) 2011-031781

(51) Int. Cl. H01M 2/30

(52) U.S. Cl. 429/211

(57) ABSTRACT

A lead member includes a flat conductor having a top face and a bottom face, and insulation films adhered onto both faces of the conductor at a middle portion of the conductor along a length direction of the conductor. The conductor includes a base material that is copper and a nickel plated layer on the base material. A thickness of the conductor has a value larger than, or equal to 0.05 mm, and smaller than, or equal to 0.2 mm. A width of the conductor has a value larger than, or equal to 2 mm, and smaller than, or equal to 7 mm. A thickness of the nickel plated layer has a value larger than, or equal to 2.5 μm, and smaller than, or equal to 5.0 μm.

### CROSS REFERENCE TO RELATED APPLICATION(S)

The present disclosure relates to the subject matters contained in Japanese Patent Application No. 2011-031781 filed on Feb. 17, 2011, which are incorporated herein by reference in its entirety.

### FIELD

One or more embodiments of the present invention are related to a lead member which is connected to an electrode of a slim type battery, and is derived out from the battery.

### BACKGROUND

JP-A-2002-075324 discloses that lead members are welded to battery elements within a slim type battery.

JP-A-2007-257849 discloses that nickel plated copper is used as an anode terminal lead, the anode terminal lead and a cathode terminal lead are welded, and furthermore, are fixed by utilizing either rivets or screws between batteries.

A lead member, the one end of which is connected to a metal foil corresponding to a portion of power generating elements of a battery and the other end of which is derived out from the battery, is made of a conductor and insulation films, while the insulation films cover a portion of the conductor. The lead member is melted to an exterior material of the battery at a portion of the insulation films. At a place where the lead member is melted to the exterior material of the battery, since the insulation films cover the conductor of this portion, the conductor is not directly melted to the exterior material.

Nickel is frequently used as metal foils which constitute anodes among power generating elements within batteries. In case that while the same sort of metal as the sort of metal foils is used as conductors of lead members, metal foils of anodes are nickel, nickel has been conventionally used as lead members for anodes. Although the metal foils are welded with the lead members, since the nickel materials are welded with each other in the conventional technique, there is no problem that the metal foils could have been welded with the lead members.

However, in connection with such a trend that capacities of batteries are increased, lead members for anodes made of nickel generate heat due to electric resistance values thereof, and thus, become high temperatures when batteries are operated. Since the lead members are brought into the high temperature conditions, separators within the batteries and adhesive materials for sealing exterior materials are deteriorated. As a result, there may be a problem that functions of the batteries are damaged. Also, there may be another problem that useless power consumption within the lead members can be hardly neglected.

Therefore, it is conceivable that copper whose resistance value is small is used for lead members for anodes. However, when pure copper is used, there are some possibilities that insulation films for covering the pure copper are deteriorated due to copper-catalyzed deterioration, and close contacts between the deteriorated insulation films and exterior materials of batteries at this deteriorated portion may become insufficient, so that these insulation films cannot be utilized in batteries, for instance, electrolytic fluids within the batteries may be leaked.

As a result, it is conceivable that such a nickel plated copper may be employed as lead members for anodes. However, there may be another problem that even if the nickel plated copper (lead member for anodes) is welded with nickel (metal foil for anodes), sufficiently strong bond strengths could not have been obtained. Then, when the lead members are bent, there may be such a problem that a crack is produced in the plated layers, and thus, copper of base material is exposed.

### SUMMARY

An object of one or more embodiments of the invention is to provide such a lead member where nickel is plated on copper in that a sufficiently strong bond strength between the lead member and a metal foil made of nickel is achieved, and further, even when the lead member is bent, a crack is not produced in the plated layer.

According to one or more embodiments of the invention, there is provided a lead member including a flat conductor having a top face and a bottom face; and insulation films adhered onto both faces of the conductor at a middle portion of the conductor along a length direction of the conductor. The conductor includes base material that is copper and a nickel plated layer on the base material. A thickness of the conductor has a value larger than, or equal to 0.05 mm, and smaller than, or equal to 0.2 mm. A width of the conductor has a value larger than, or equal to 2 mm, and smaller than, or equal to 7 mm. A thickness of the nickel plated layer has a value larger than, or equal to 2.5 μm, and smaller than, or equal to 5.0 μm.

The lead member of the embodiments has sufficiently strong bond strengths with respect to the metal foil made of nickel. Even when the lead member is bent, a crack is not produced in the plated layer, and the lead member can be used with being bent.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a diagram for showing a lead member of an embodiment of the present invention.

FIG. 2 is a sectional view for indicating the lead member of the embodiment, and a sectional view of the lead member cut along a line II-II indicated in FIG. 1.

FIG. 3 is a diagram for explaining welding between the lead member and a metal foil of an electrode.

FIG. 4 is a diagram for explaining bending of conductors of the lead members which are used in a battery.

FIG. 5 is a diagram for explaining a measuring method of a bond strength between the conductor and the metal foil.

FIGS. 6A to 6C are diagrams for explaining a method for bending the conductor.

### DETAILED DESCRIPTION OF THE EMBODIMENTS

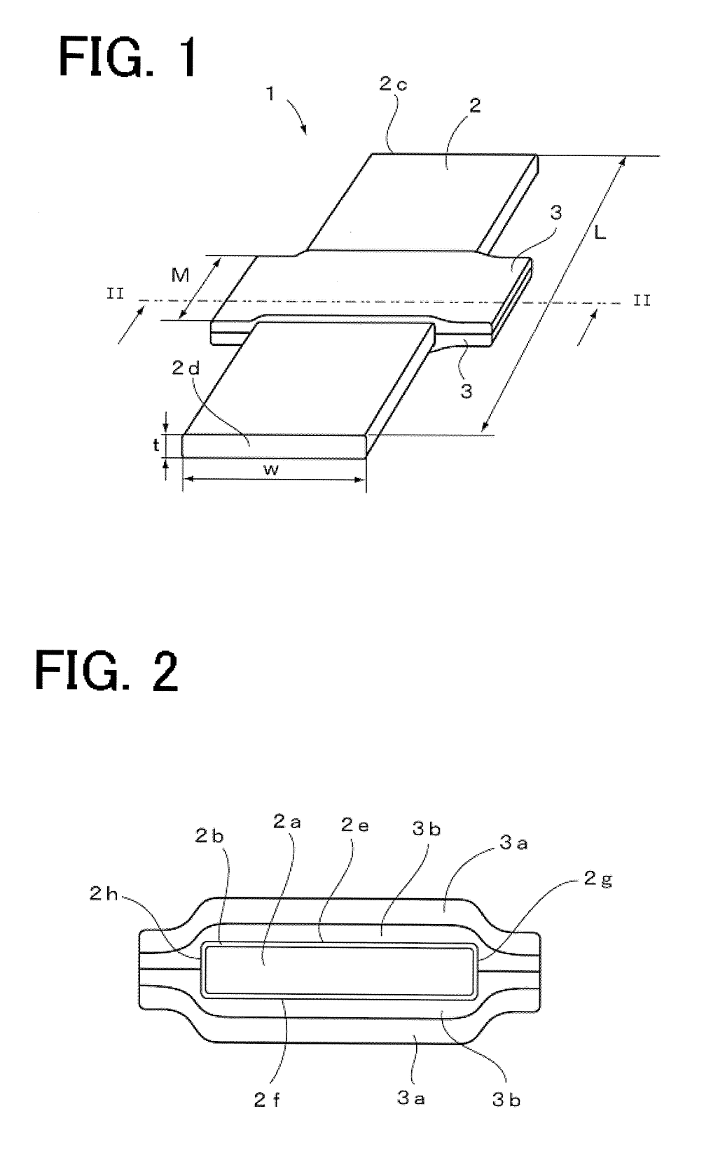

FIG. 1 indicates an outer view of a lead member 1 of an embodiment of the present invention. FIG. 2 is a drawing which is viewed along an arrow direction on a section of a line II-II indicated in FIG. 1.

The lead member 1 is made of a conductor 2 and insulation films 3.

The insulation film 3 is made of a cross-linked layer 3a and an adhesive layer 3b.

In the adhesive layer 3b, either polyethylene or polypropylene, which is denatured by acid, is employed as a base resin. A thickness of the adhesive layer 3b is set to be larger than, or equal to 0.01 mm, and smaller than, to or equal to 0.5 mm.

In the cross-linked layer 3a, either polyethylene or polypropylene is employed as a base resin. A cross-linking agent is contained by larger than, or equal to 0.5 weight %, and smaller than, or equal to 10 weight %. A thickness of the cross-linked layer 3a is set to be larger than, or equal to 0.05 mm, and smaller than, or equal to 0.1 mm.

A thickness “t” of the conductor 2 is larger than, or equal to 0.05 mm, and smaller than, or equal to 0.2 mm; a width “w” thereof is larger than, or equal to 2 mm, and smaller than, or equal to 7 mm; and a length “L” thereof is longer than, or equal to 20 mm, and shorter than, or equal to 40 mm. The insulation films 3 are adhered to both faces of a middle portion of the conductor 2. Depending upon a design of a battery, the insulation films 3 are not adhered on portions of the conductor 2 which are separated by several mm from ends 2c and 2d along the length direction thereof, so that the conductor 2 is exposed. A length “M” of the insulation films 3 is longer than, or equal to 3.5 mm, and shorter than, or equal to 7 mm.

The conductor 2 is made of base material 2a and a plated layer 2b. The base material 2a is copper, and the plated layer 2b is nickel. The middle portion of the conductor 2 is surrounded by the adhesive layers 3b of the insulation films 3.

As shown in FIG. 2, both faces 2e and 2f of the conductor 2, and end faces 2g and 2h thereof along the width direction have been plated. Since the plated layer 2b is present between the base material (copper) 2a and the insulation films 3, there is no possibility that copper is directly contacted to the insulation films 3. As a consequence, there is no possibility that the insulation films 3 are deteriorated by copper.

The lead member 1 of the embodiment can be manufactured by that the insulation films 3 are adhered in a predetermined interval on the conductor 2 whose length is long, and then, the conductor 2 is cut at a predetermined place between the insulation films 3. In this case, the cut faces (namely, end faces of conductor 2 along length direction) 2c and 2d of the conductor 2 have not been plated. Even if copper is exposed from these end faces 2c and 2d, since copper is not contacted to the insulation films 3, there is no risk that the copper-catalyzed degradation of the films occurs. As a consequence, there is no problem that copper remains exposed on the cut faces 2c and 2d (namely, end faces thereof along length direction) of the conductor 2.

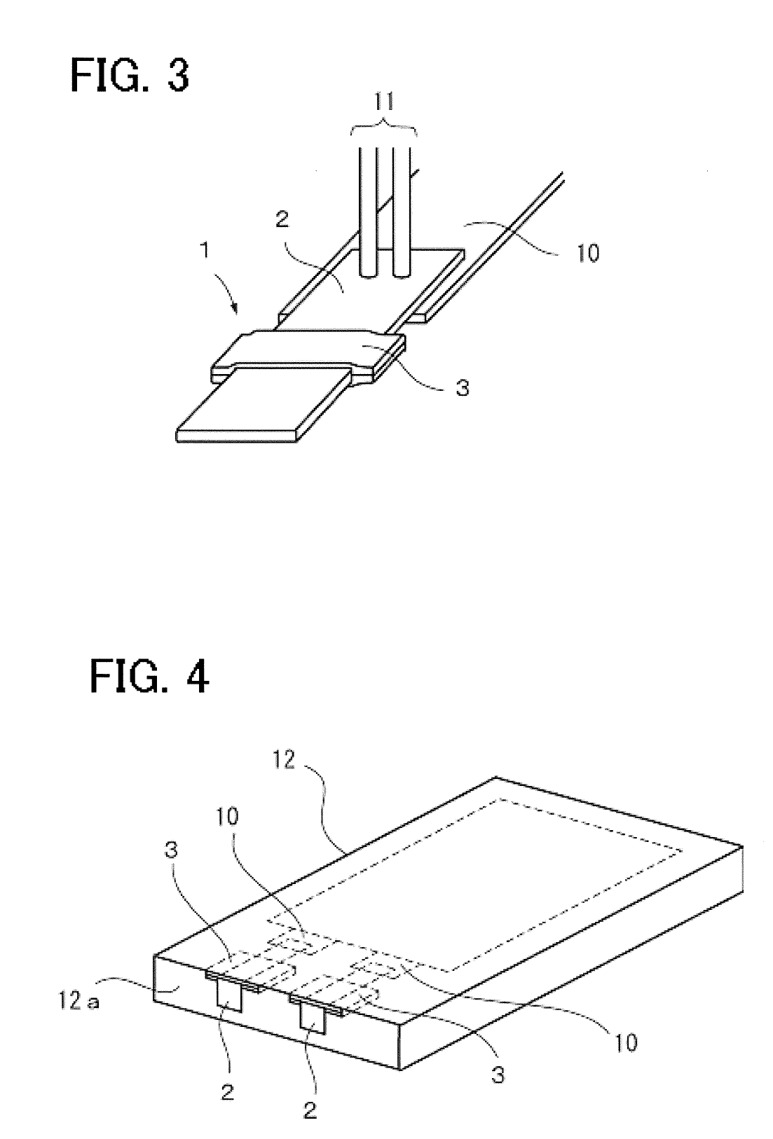

When an electrode metal foil 10 is welded with the lead member 1, as shown in FIG. 3, electrode rods 11 for welding abuts against a place where both the electrode metal foil 10 and the lead member 1 are overlapped with each other, and current is supplied between the electrode rods 11. Since the width “w” of the conductor 2 is 4 to 7 mm, an interval between the electrode rods 11 becomes 1 to 3 mm. Since electric power of several KVA is supplied between the electrode rods 11, the electrode metal foil 10 and the conductor 2 of the lead member 1 are melted by resistance heating so as to be spot-welded. A portion to be welded is a portion to which tips of the electrode rods 11 are contacted, and is such a portion having a diameter on the order of 1 mm.

On one hand, a predetermined bond strength is required with respect to the welded portion of the electrode metal foil 10 and the conductor 2. This bond strength can be expressed based upon force produced when the conductor welded on the electrode metal foil 10 is upwardly pulled up at 90 degrees by holding one end portion of this conductor and is stripped off (90-degree exfoliation). It is required that the conductor 2 is not stripped off from the electrode metal foil 10 if the force greater than, or equal to 2 kilograms (kg) is not applied thereto. As a result of considerations made by the Inventors of the present invention, when a dimension of the conductor 2 is selected to be the above-described dimension, bond strengths become different, depending upon a thickness of the plated layer 2b. If a thickness of the nickel plated layer 2b of nickel plated copper corresponding to the conductor 2 of the lead member 1 is thicker than, or equal to 2.5 μm, then a bond strength between the electrode metal foil (nickel) 10 and the conductor (nickel plated copper) 2 of the lead member 1 is large, and thus, superior bonding is achieved. On the other hand, if a thickness of the nickel plated layer 2b is thinner than 2.5 μm, then a bonding strength between the electrode metal foil (nickel) 10 and the conductor (nickel plated layer) 2 of the lead member 1 becomes smaller than 2.0 kg. Thus, there are some possibilities that bonding becomes insufficient.

In the lead member 1 of the embodiment, one end portion thereof is connected to the electrode metal foil 10. The connecting portion of the lead member 1 and the electrode metal foil 10 is covered with an exterior material 12. A main body of a battery is the exterior material 12 and an internal portion thereof, and the other end portion of the lead member 1 is outwardly derived from the main body of the battery. The insulation film 3 is sealed to the exterior material 12. There are some possibilities that the conductor 2 derived outside the main body of the battery is bent in the vicinity of the edge of the insulation film 3 by being matched to the shape of the exterior material 12. For example, as represented in FIG. 4, the conductors 2 derived from one edge of the exterior material 12 having a rectangular parallelepiped shape are bent at the edge of the insulation film 3, and are then bent in such a manner that the conductors are closely contacted to an end face 12a of the exterior material 12. Even if the conductors 2 are bent in the above-described manner, it is required to avoid that a crack is produced in the plated layer 2b, and copper of the base material 2a is exposed.

As a result of considerations made by the Inventors of the present invention, the below-mentioned facts were revealed: That is, in case that the thickness of the conductor 2 was 0.05 mm to 0.2 mm, if the thickness of the nickel plated layer 2b of this conductor 2 was thinner than, or equal to 5 μm, then a crack was not produced in the plated layer 2b when the conductor 2 was bent at 180 degrees. However, there were some possibilities that if the thickness of the nickel plated layer 2b was thicker than 5 μm, then a crack was produced in the plated layer 2b when the conductor 2 was bent at 180 degrees, so that copper of the base material 2a was exposed.

As previously explained, in the lead member 1 of the present invention, the copper base material 2a plated by nickel is employed as the conductor 2. When the conductor 2 has such a dimension that the thickness thereof has the value larger than, or equal to 0.05 mm, and smaller than, or equal to 0.2 mm, and the width thereof has the value larger than, or equal to 2 mm, and smaller than, or equal to 7 mm, the thickness of the nickel plated layer 2b is set to be such a value larger than, or equal to 2.5 μm, and smaller than, or equal to 5.0 μm. As a result, the bond strength produced when the lead member 1 is connected to the electrode metal foil 10 made of nickel is secured, and furthermore, even when the conductors 2 of the lead member 1 which are derived outside the battery are turned down, no crack is produced in the nickel plated layer 2b.

### ILLUSTRATIVE EXAMPLES

As to lead members having dimensions indicated in the below-mentioned examples, the following investigations were performed: namely, bond strengths obtained when the conductors were welded to metal foils made of nickel, and whether or not a crack was produced in plated layers when the conductors were bent.

A description will be made of a method for measuring bond strengths obtained between the conductors and the metal foils made of nickel as follows:

The conductors are spot-welded to the metal foils made of nickel. The below-mentioned welding condition is similarly given to the respective examples:

Distance between electrodes: 1.0 mm
Electric power supplied between electrodes: 3.5 KVA
Power supplying time: 3 milliseconds

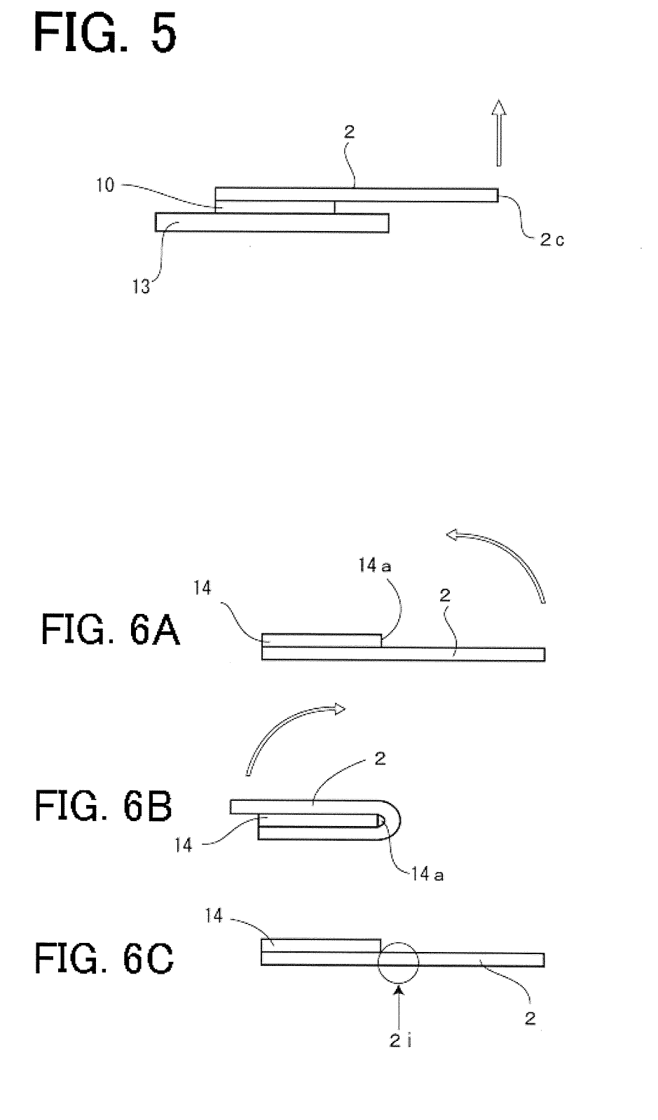

As shown in FIG. 5, the metal foil 10 made of nickel (thickness being 0.2 mm) to which the conductor 2 has been welded is adhered to a plate 13 to be fixed. The plate 13 is fixed to a slide table (not shown) by utilizing a 90-degree exfoliation testing machine (not shown).

While an end portion 2c of the conductor 2 is held, this end portion 2c is upwardly pulled up at 90 degrees with respect to the plate 13 (direction denoted by arrow in FIG. 5). Maximum load until a welded portion is stripped off is measured. It is assumed that such a lead member the maximum load to which is larger than or equal to 2.0 kg is determined to be OK, whereas another lead member the maximum load to which is smaller than 2.0 kg is determined to be NG.

A method for checking whether or not a crack is produced in a plated layer when a conductor is bent will be described as follows:

as represented in FIG. 6A, a copper foil 14 having a thickness of 0.1 mm is disposed on the conductor 2, the conductor 2 is bent at 180 degrees while an end portion 14a of the copper foil 14 is set to a fulcrum, and then, the bent conductor 2 is overlapped on the copper foil 14. The bent conductor 2 as shown in FIG. 6B is straightened to the original condition while the end portion 14a of the copper foil 14 is set to the fulcrum (see FIG. 6C). An observation is carried out whether or not a crack is produced in a plated layer of a bent portion 2i of the conductor 2.

### Illustrative Example 1

Thickness of copper foil: 0.05 mm
Width of copper foil: 2 mm
Thickness of nickel plated layer: 2.5 μm
Bond strength: OK
Crack produced when conductor is bent: None

### Illustrative Example 2

Thickness of copper foil: 0.2 mm
Width of copper foil: 7 mm
Thickness of nickel plated layer: 5.0 μm
Bond strength: OK
Crack produced when conductor is bent: None

### Comparative Example 1

Thickness of copper foil: 0.1 mm
Width of copper foil: 4 mm
Thickness of nickel plated layer: 1.0 μm
Bond strength: NG
Crack produced when conductor is bent: None

### Comparative Example 2

Thickness of copper foil: 0.2 mm
Width of copper foil: 7 mm
Thickness of nickel plated layer: 10 μm
Bond strength: OK
Crack produced when conductor is bent: Present

As indicated in the illustrative examples, if lead members are manufactured by that such nickel layers having thickness values larger than, or equal to 2.5 μm, and smaller than, or equal to 5.0 μm are plated on conductors (copper foils), the thicknesses of which are larger than, or equal to 0.05 mm, and smaller than, or equal to 0.2 mm, and the widths of which are larger than, or equal to 2 mm, and smaller than, or equal to 7 mm, then bond strengths obtained when the nickel-plated conductors are welded to metal foils made of nickel become larger than, or equal to 2.0 kg, namely the resulting lead members are determined to be OK. Moreover, even when the conductors are turned down at 180 degrees, a crack is not produced in the nickel plated layers.

On the other hand, as shown in the comparative examples, even when the dimensions of the copper foils are similar to those of the illustrative examples, if the thicknesses of the nickel plated layers are not included within the range of the present embodiment, then there are the below-mentioned inconvenient events. That is, the bond strengths are insufficient values, or the cracks are produced in the nickel plated layers when the conductors are bent.

What is claimed is:

1. A lead member comprising
a flat conductor having a top face and a bottom face; and
insulation films adhered onto both faces of the conductor at a middle portion of the conductor along a length direction of the conductor, wherein:
the conductor comprises a base material that is copper and a nickel plated layer on the base material;
a thickness of the conductor has a value larger than, or equal to 0.05 mm, and smaller than, or equal to 0.2 mm;
a width of the conductor has a value larger than, or equal to 2 mm, and smaller than, or equal to 7 mm; and
a thickness of the nickel plated layer has a value larger than, or equal to 2.5 μm, and smaller than, or equal to 5.0 μm.
